(19) United States
(12) Patent Application Publication
(10) Pub. No.: US 2023/0090548 A1
(43) Pub. Date: Mar. 23, 2023

(54) DRIVE APPARATUS

(71) Applicant: NIDEC CORPORATION, Kyoto (JP)

(72) Inventors: Yuki ISHIKAWA, Kyoto (JP); Shuhei NAKAMATSU, Kyoto (JP); Hitoshi KUROYANAGI, Kyoto (JP)

(21) Appl. No.: 17/939,963

(22) Filed: Sep. 8, 2022

(30) Foreign Application Priority Data
Sep. 15, 2021 (JP) 2021-150423

(51) Int. Cl. H02K 11/33; H02P 27/06; H02K 5/20; H02K 7/116; H02K 9/19

(52) U.S. Cl. CPC H02K 11/33; H02P 27/06; H02K 5/20; H02K 7/116; H02K 9/19

(57) ABSTRACT

A drive apparatus includes an inverter accommodated in an inverter housing, a cooling flow path through which a first fluid for cooling the inverter can flow, and a heat exchanger configured to allow a second fluid for cooling a motor to exchange heat with the first fluid. The inverter includes a first element and a second element arranged side by side in a second direction perpendicular to the first direction. The cooling flow path includes a first cooling portion that cools the first element with the first fluid, a second cooling portion that cools the second element with the first fluid, a first connection flow path that connects the first cooling portion and the second cooling portion, and a second connection flow path that connects the second cooling portion and the heat exchanger.

### CROSS-REFERENCE TO RELATED APPLICATIONS

The present invention claims priority under 35 U.S.C. § 119 to Japanese Patent Application No. 2021-150423 filed on Sep. 15, 2021, the entire content of which is incorporated herein by reference.

### FIELD OF THE INVENTION

The present invention relates to a drive apparatus.

### BACKGROUND

Conventionally, there has been known a drive apparatus including a motor, an inverter that supplies power to the motor, and an inverter housing that houses the inverter.

In the drive apparatus, as the motor becomes larger, the amount of heat generated by the electronic components mounted on the inverter becomes larger. Therefore, it is necessary to cool not only the motor but also the inverter.

However, the flow path for cooling the inverter becomes complicated depending on the arrangement of electronic components and may, for example, cross itself in the inverter housing. The drive device may be increased in size due to the complication of the flow path.

### SUMMARY

An exemplary drive apparatus according to the present invention includes a motor, an inverter, a motor housing, an inverter housing, a cooling flow path, and a heat exchanger. The inverter supplies power to the motor. The motor housing accommodates the motor. The inverter housing accommodates the inverter. In the cooling flow path, a first fluid for cooling the inverter can flow. In the heat exchanger, a second fluid for cooling the motor can exchange heat with the first fluid. The motor has a motor shaft. The motor shaft extends along a central axis parallel to the first direction and is rotatable about the central axis. The inverter includes a first element and a second element. The first element and the second element are arranged in a second direction perpendicular to the first direction. The cooling flow path includes a first cooling portion, a second cooling portion, a first connection flow path, and a second connection flow path. The first cooling portion cools the first element with the first fluid. The second cooling portion cools the second element with the first fluid. The first connection flow path connects the first cooling portion and the second cooling portion. The second connection flow path connects the second cooling portion and the heat exchanger.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual diagram illustrating a configuration example of a drive apparatus;

FIG. 2 is a perspective view of the drive apparatus according to the embodiment;

FIG. 3 is a schematic diagram illustrating an example of a vehicle having the drive apparatus mounted thereon;

FIG. 4A is a schematic view illustrating a configuration example of a cooling flow path according to the embodiment;

FIG. 4B is a schematic view illustrating another configuration example of a cooling flow path according to the embodiment;

FIG. 5 is a conceptual diagram illustrating another arrangement example of the cooling flow path in the inverter housing;

FIG. 6 is a perspective view of the drive apparatus according to a modification;

FIG. 7A is a schematic view illustrating a configuration example of a cooling flow path according to the modification; and

FIG. 7B is a schematic view illustrating another configuration example of a cooling flow path according to the modification.

### DETAILED DESCRIPTION

Exemplary embodiments will be described with reference to the drawings hereinafter.

The following description will be made with a gravity direction being partitioned based on a positional relationship in a case where a drive apparatus 100 is mounted in a vehicle 300 located on a horizontal road surface. In the drawings, an XYZ coordinate system is appropriately illustrated as a three-dimensional orthogonal coordinate system. In the XYZ coordinate system, a Z-axis direction is an example the “third direction” according to the third embodiment indicates a vertical direction (that is, up-down direction). The +Z direction is an example of “one of the third directions” in the present invention and indicates an upward direction (a vertically upward direction opposite to the gravity direction). The −Z direction is an example of “the other of the third directions” in the present invention and indicates a downward direction (a vertically downward direction in the same direction as the gravity direction).

In addition, an X-axis direction is a direction orthogonal to the Z-axis direction and illustrates a front-rear direction of the vehicle 300 in which the drive apparatus 100 is mounted. The X-axis direction is an example of “the second direction” in the present invention. The +X direction is an example of “one of the second directions” in the present invention and indicates one of the front and the rear of the vehicle 300. The −X direction is an example of “the other of the second directions” in the present invention and indicates the other of the front and the rear of the vehicle 300.

The Y-axis direction is a direction perpendicular to both the X-axis direction and the Z-axis direction, and is a width direction (right-left direction) of the vehicle 300. The Y-axis direction is an example of “the first direction” in the present invention. In the +Y direction, the “Y-axis direction” indicates the left side of the vehicle 300, and the −Y direction indicates the right side of the vehicle 300. However, when the +X direction is the rear of the vehicle 300, the +Y direction can be the right side of the vehicle 300, and the −Y direction can be the left side of the vehicle 300. That is, regardless of the X-axis direction, the +Y direction simply becomes one side in the right-left direction of the vehicle 300, and the −Y direction becomes the other side in the right-left direction of the vehicle 300. In addition, depending on a method for mounting the drive apparatus 100 on the vehicle 300, the X-axis direction can be the width direction (right-left direction) of the vehicle 300, and the Y-axis direction can be the front-rear direction of the vehicle 300. In the following description, the Y-axis direction is parallel to, for example, a first rotation axis J1 of the motor 2.

In the following description, a direction orthogonal to a predetermined axis is simply referred to as a “radial direction”, and a circumferential direction about a predetermined axis is referred to as a “circumferential direction”. In the radial direction, an orientation approaching an axis is referred to as a “radial inner side”, and an orientation separating from the axis is referred to as a “radial outer side”.

In the present specification, in the positional relationship between any one of orientations, lines, and surfaces and another one, the term “parallel” means not only a state where both never cross each other no matter how long they extend, but also a state where both are substantially parallel. In addition, the term “perpendicular” includes not only a state where both intersect each other at 90 degrees, but also a state where both are substantially perpendicular. That is, the terms “parallel” and “perpendicular” each include a state where the positional relationship between both permits an angular deviation to a degree that does not depart from the gist of the present invention.

In the present specification, an “annular shape” includes not only a shape continuously connected without any cut along the entire circumferential direction about a predetermined axis such as the first rotation axis J1 but also a shape having one or more cuts in a part of the entire circumference direction about the predetermined axis. In addition, a shape that draws a closed curve around a predetermined axis in a curved surface intersecting with the predetermined axis is also included.

Note that these are names used merely for description, and are not intended to limit actual positional relationships, directions, names, and the like.

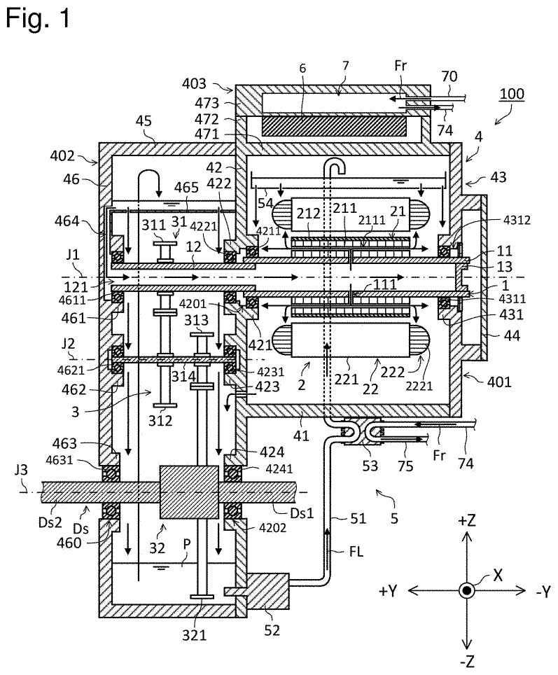

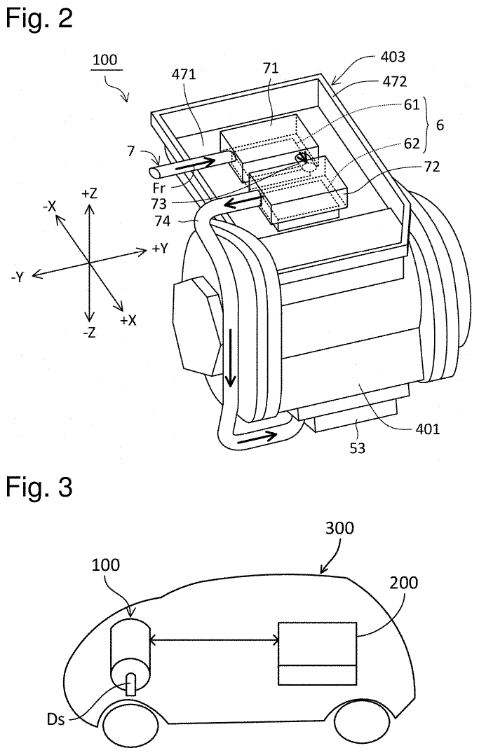

FIG. 1 is a conceptual diagram illustrating a configuration example of the drive apparatus 100. FIG. 2 is a perspective view of the drive apparatus 100 according to the embodiment. FIG. 3 is a schematic diagram illustrating an example of a vehicle 300 having the drive apparatus 100 mounted thereon. Note that FIGS. 1 and 2 are merely conceptual diagrams, and a layout and a dimension of each portion are not necessarily identical to those of the actual drive apparatus 100 in a strict sense. Referring to FIG. 2, in order to make the configuration of a cooling flow path 7 (to be described later) easily viewable, a portion other than the cooling flow path 7 of a lid portion 473 (to be described later) is omitted. FIG. 3 conceptually illustrates the vehicle 300. In the present embodiment, the +X direction is the front of the vehicle 300, and the −X direction is the rear of the vehicle 300. However, the +X direction can be the rear of the vehicle 300, and the −X direction can be the front of the vehicle 300.

In the present embodiment, as illustrated in FIG. 3, the drive apparatus 100 is mounted on the vehicle 300 using at least a motor as a power source. The vehicle 300 is, for example, a hybrid vehicle (HV), a plug-in hybrid vehicle (PHV), or an electric vehicle (EV). The vehicle 300 has the drive apparatus 100. Referring to FIG. 3, the drive apparatus 100 drives front wheels of the vehicle 300. However, the present invention is not limited to the example illustrated in FIG. 3, and the drive apparatus 100 may drive at least one of the wheels. In addition, the vehicle 300 further includes a battery 200. The battery 200 stores electric power to be supplied to the drive apparatus 100.

As illustrated in FIGS. 1 and 2, the drive apparatus 100 includes a motor 2, a gear portion 3, a housing 4, a fluid circulation portion 5, an inverter 6, and a cooling flow path 7.

The motor 2 is a DC brushless motor. As described above, the drive apparatus 100 includes the motor 2. The motor 2 is the drive source of the drive apparatus 100 and is driven by power supplied from the inverter 6. The motor 2 is of an inner rotor type in which the rotor 21 is rotatably disposed radially inward of the stator 22. As illustrated in FIG. 1, the motor 2 includes a motor shaft 1, the rotor 21, and the stator 22.

The motor shaft 1 extends along the first rotation axis J1 parallel to the Y-axis direction and is rotatable about the first rotation axis J1. The first rotation axis J1 is an example of the “central axis” in the present invention. As described above, the motor 2 has the motor shaft 1. The motor shaft 1 has a tubular shape extending in the Y-axis direction. A fluid FL flows inside the motor shaft 1. The drive apparatus 100 further includes the fluid FL. Note that the fluid FL is a lubricant that lubricates the gear portion 3 and each bearing of the drive apparatus 100, and is, for example, an automatic transmission fluid (ATF) in the present embodiment. In addition, the fluid FL is used as a refrigerant for cooling the motor 2 and the like.

The motor shaft 1 includes a rotor shaft 11 and a gear shaft 12. The rotor shaft 11 holds the rotor 21. The gear shaft 12 is connected to the +Y direction side end of the rotor shaft 11. The rotor shaft 11 and the gear shaft 12 have a tubular shape extending in the Y-axis direction and extend along the first rotation axis J1. In the present embodiment, the both are connected by spline fitting. Alternatively, the divided shafts 1 may be connected by screw coupling using a male screw and a female screw or may be joined by a fixing method such as press-fitting and welding. When the fixing method such as press-fitting or welding is adopted, serrations combining recesses and protrusions extending in the Y-axis direction may be adopted. With such a configuration, it is possible to reliably transmit rotation from the rotor shaft 11 to the gear shaft 12. However, the present invention is not limited to the example of the present embodiment, and the motor shaft 1 may be a single member.

The motor shaft 1 has a shaft through-hole 111. The shaft through-hole 111 is disposed in the rotor shaft 11 and penetrates the tubular rotor shaft 11 in the radial direction. The number of shaft through-holes 111 may be singular or plural. When the motor shaft 1 rotates, the fluid FL inside the motor shaft 1 flows out of the rotor shaft 11 through the shaft through-hole 111 by centrifugal force. Note that the above-described example does not exclude a configuration in which the shaft through-hole 111 and the rotor through-hole 2111 are omitted.

The motor shaft 1 has an inlet 121. The inlet 121 is an opening in an end portion of the motor shaft 1 which is located on the +Y direction side and is an opening in an end portion of the gear shaft 12 (to be described later) which is located on the +Y direction side in the present embodiment. The inlet 121 is connected to a flow path 464 of a gear lid portion 46 described later. The fluid FL flows into the motor shaft 1 from the flow path 464 through the inlet 121.

The motor shaft 1 further includes a shaft wall portion 13. The shaft wall portion 13 is disposed inside the rotor shaft 11 on the −Y direction side and expands in the radial direction. The shaft wall portion 13 is disposed in the −Y direction with respect to the shaft through-hole 111. The shaft wall portion 13 closes the opening of the end portion of the rotor shaft 11 which is located on the −Y direction side. A radially outer end portion of the shaft wall portion 13 is connected to an inner surface of the rotor shaft 11. The shaft wall portion 13 may be integrated with the rotor shaft 11 or may be separated from the rotor shaft 11.

The rotor 21 is rotatable together with the motor shaft 1. The drive apparatus 100 includes the rotor 21. The rotor 21 is fixed to the motor shaft 1 and is rotatable about the first rotation axis J1. The rotor 21 rotates when electric power is supplied from the inverter 6 of the drive apparatus 100 to the stator 22. The rotor 21 includes a rotor core 211 and a magnet 212. The rotor core 211 is a magnetic body and is formed by, for example, stacking thin electromagnetic steel plates in the Y-axis direction. The rotor core 211 is fixed to the radially outer surface of the rotor shaft 11. A plurality of the magnets 212 are fixed to the rotor core 211. The plurality of magnets 212 are arranged along the circumferential direction with magnetic poles arranged alternately.

In addition, the rotor core 211 has the rotor through-hole 2111. The rotor through-hole 2111 penetrates the rotor core 211 in the Y-axis direction and is connected to the shaft through-hole 111. The rotor through-hole 2111 is used as a flow path of the fluid FL that also functions as the refrigerant. When the rotor 21 rotates, the fluid FL flowing through the inside of the motor shaft 1 can flow into the rotor through-hole 2111 via the shaft through-hole 111. In addition, the fluid FL flowing into the rotor through-hole 2111 can flow out from both end portions of the rotor through-hole 2111 in the Y-axis direction to the outside. The fluid FL having flowed out flies toward the stator 22 and cools, for example, a coil portion 222 (particularly, a coil end 2221 thereof) to be described later and the like. In addition, the flowed fluid FL flies toward a first motor bearing 4211, a second motor bearing 4311, and the like that rotatably support the motor shaft 1, and lubricates and cools the bearings.

The stator 22 is arranged radially outward of the rotor 21. The drive apparatus 100 includes the stator 22. The stator 22 faces the rotor 21 with a gap therebetween in the radial direction. The stator 22 includes a stator core 221 and the coil portion 222. The stator 22 is held by a first housing tubular portion 41 to be described later. The stator core 221 has a plurality of magnetic pole teeth (not shown) extending radially inward from an inner surface of an annular yoke (not shown). The coil portion 222 is formed by winding a conductive wire around the magnetic pole teeth via an insulator (not illustrated). The coil portion 222 has the coil end 2221 protruding from the end surface of the stator core 221 in the Y-axis direction

Next, the gear portion 3 is connected to the +Y direction side of the motor shaft 1 and is connected to the gear shaft 12 in the present embodiment. The gear portion 3 is a power transmission device that transmits power of the motor 2 to a drive shaft Ds to be described later. The gear portion 3 includes a reduction gear 31 and a differential device 32.

The reduction gear 31 is connected to the gear shaft 12. The reduction gear 31 is arranged to increase the torque outputted from the motor 2 in accordance with a reduction ratio while reducing the rotation speed of the motor 2. The reduction gear 31 transmits the torque output from the motor 2 to the differential device 32. The reduction gear 31 includes a first gear 311, a second gear 312, a third gear 313, and an intermediate shaft 314.

The first gear 311 is fixed to the radially outer surface of the motor shaft 1 on the +Y direction side of the motor shaft 1. The gear portion 3 includes the first gear 311. For example, the first gear 311 is disposed on the radially outer surface of the gear shaft 12. The first gear 311 may be integrated with the gear shaft 12 or may be separated from the gear shaft 12 and firmly fixed to the radially outer surface of the gear shaft 12. The first gear 311 is rotatable about the first rotation axis J1 together with the motor shaft 1.

The intermediate shaft 314 extends along a second rotation axis J2 and is rotatable about the second rotation axis J2. The second rotation axis J2 extends in the Y-axis direction. The gear portion 3 includes the intermediate shaft 314. Both ends of the intermediate shaft 314 are supported rotatably about the second rotation axis J2 by a first intermediate bearing 4231 and a second intermediate bearing 4621.

The second gear 312 is fixed to the radially outer surface of the intermediate shaft 314 and meshes with the first gear 311. The third gear 313 is fixed to the radially outer surface of the intermediate shaft 314. The gear portion 3 includes the second gear 312 and the third gear 313. The third gear 313 is disposed in the −Y direction with respect to the second gear and meshes with a fourth gear 321 of the differential device 32. Each of the second gear 312 and the third gear 313 may be integrated with the intermediate shaft 314 or may be separated from the intermediate shaft 314 and firmly fixed to the radially outer surface of the intermediate shaft 314. The second gear 312 and the third gear 313 are rotatable about the second rotation axis J2 together with the intermediate shaft 314.

The torque of the motor shaft 1 is transmitted from the first gear 311 to the second gear 312. Then, the torque transmitted to the second gear 312 is transmitted to the third gear 313 via the intermediate shaft 314. Furthermore, the torque is transmitted from the third gear 313 to the fourth gear 321 of the differential device 32.

The differential device 32 is attached to the drive shaft Ds and transmits torque transmitted from the reduction gear 31 to the drive shaft Ds. The differential device 32 includes a fourth gear 321 that meshes with the third gear 313. The fourth gear 321 is a so-called ring gear. The torque of the fourth gear 321 is output to the drive shaft Ds.

The drive shaft Ds includes a first drive shaft Ds1 and a second drive shaft Ds2. The first drive shaft Ds1 is attached to the −Y direction side of the differential device 32. The second drive shaft Ds2 is attached in the +Y direction side of the differential device 32. For example, the differential device 32 transmits the torque to the drive shafts Ds1 and Ds2 on both the Y-axis sides while absorbing a rotation speed difference between the drive shafts Ds1 and Ds2 on both the Y-axis sides when the vehicle 300 turns.

The housing 4 accommodates the motor 2. As described above, the drive apparatus 100 includes the housing 4. More specifically, the housing 4 accommodates the motor shaft 1, the rotor 21, the stator 22, the gear portion 3, and the like. The housing 4 includes a first housing tubular portion 41, a side plate portion 42, the housing lid portion 43, a cover member 44, a second housing tubular portion 45, and the gear lid portion 46. Note that the first housing tubular portion 41, the side plate portion 42, the housing lid portion 43, the cover member 44, the second housing tubular portion 45, and the gear lid portion 46 are formed using, for example, a conductive material, and in the present embodiment, are formed using a metal material such as iron, aluminum, or an alloy thereof. In addition, these are preferably formed using the same material in order to suppress contact corrosion of dissimilar metals at the contact portion. However, the present invention is not limited to this example, and these may be formed using materials other than the metal materials, or at least a part of these may be formed using different materials.

The housing 4 further includes a motor housing 401, a gear housing 402, and an inverter housing 403. These will be described later.

The first housing tubular portion 41 has a tubular shape extending in the Y-axis direction. The motor 2, a fluid reservoir 54 (to be described later), and the like are arranged inside the first housing tubular portion 41. In addition, a stator core 221 is fixed to the inner surface of the first housing tubular portion 41.

The side plate portion 42 covers the end portion of the first housing tubular portion 41 which is located on the +Y direction side and covers the end portion of the second housing tubular portion 45 which is located on the −Y direction side. The side plate portion 42 expands in a direction intersecting the first rotation axis J1 and divides the first housing tubular portion 41 from the second housing tubular portion 45. In the present embodiment, the first housing tubular portion 41 and the side plate portion 42 are integrated. As a result, the rigidity of these portions can be enhanced. However, the present invention is not limited to this example, and both may be separate bodies.

The side plate portion 42 has a side plate through-hole 4201 and a first drive shaft through-hole 4202. The side plate through-hole 4201 and the first drive shaft through-hole 4202 penetrates the side plate portion 42 in the Y-axis direction. The center of the side plate through-hole 4201 coincides with the first rotation axis J1. The motor shaft 1 extends through the side plate through-hole 4201. The center of the first drive shaft through-hole 4202 coincides with the third rotation axis J3. The first drive shaft Ds1 extends through the first drive shaft through-hole 4202. An oil seal (not illustrated) for sealing between the first drive shaft Ds1 and the first drive shaft through-hole 4202 is arranged in a gap therebetween.

In addition, the side plate portion 42 further includes a first motor bearing holder 421, a first gear bearing holder 422, a first intermediate bearing holder 423, and a first drive bearing holder 424. The first motor bearing holder 421 is disposed on the −Y direction side of the inner surface of the side plate through-hole 4201 and holds the first motor bearing 4211. The first motor bearing 4211 rotatably supports the end portion of the rotor shaft 11 which is located on the +Y direction side. The first gear bearing holder 422 is disposed on the +Y direction side of the inner surface of the side plate through-hole 4201 and holds a first gear bearing 4221. The first gear bearing 4221 rotatably supports the end portion of the gear shaft 12 which is located on the −Y direction side. The first intermediate bearing holder 423 is arranged on the end surface of the side plate portion 42 which is located on the −Y direction side and holds the first intermediate bearing 4231. The first intermediate bearing 4231 rotatably supports the end portion of the intermediate shaft 314 which is located on the −Y direction side. The first drive bearing holder 424 is disposed on the inner surface of the first drive shaft through-hole 4202 and holds the first drive bearing 4241. The first drive bearing 4241 rotatably supports the first drive shaft Ds1.

The housing lid portion 43 extends in a direction intersecting the first rotation axis J1 and covers the end portion of the first housing tubular portion 41 in the −Y direction. The housing lid portion 43 can be fixed to the first housing tubular portion 41 by, for example, a screw, but is not limited thereto, and a method of firmly fixing the housing lid portion 43 to the first housing tubular portion 41, such as screwing or press-fitting, can be widely adopted. As a result, the housing lid portion 43 can be brought into close contact with the end portion of the first housing tubular portion 41 which is located on the −Y direction side. Note that the term “close contact” means to have such a sealing property to an extent that the fluid FL inside the members does not leak to the outside and to an extent that foreign matter such as external water, dirt, or dust does not enter. It is assumed that the same is applied below for the close contact.

In addition, the housing lid portion 43 includes a second motor bearing holder 431. The second motor bearing holder 431 holds a second motor bearing 4311. The second motor bearing 4311 rotatably supports the end portion of the rotor shaft 11 which is located on the −Y direction side. The second motor bearing holder 431 has an opening portion 4312 through which the rotor shaft 11 extends. The opening portion 4312 penetrates the housing lid portion 43 in the axial direction and surrounds the first rotation axis J1 when viewed from the axial direction.

The cover member 44 is disposed on the end surface of the housing lid portion 43 which is located on the −Y direction side and covers the opening portion 4312 and the end portion of the motor shaft 1 which is located on the −Y direction side. The cover member 44 can be attached to the housing lid portion 43 by, for example, screwing, but is not limited thereto, and a method of firmly fixing the cover member 44 to the housing lid portion 43, such as screwing or press-fitting, can be widely adopted. A rotation detector (for example, a resolver) that detects the rotation angle of the rotor can be accommodated in a space surrounded by the cover member 44 and the housing lid portion 43. In this space, a neutralization apparatus that electrically connects the motor shaft 1 and the housing 4 may be disposed.

The second housing tubular portion 45 has a tubular shape surrounding the gear portion 3 and extends in the Y-axis direction. The end portion of the second housing tubular portion 45 which is located on the −Y direction side is connected to the side plate portion 42 and covered with the side plate portion 42. In the present embodiment, the second housing tubular portion 45 is detachably attached to the end portion of the side plate portion 42 which is located on the +Y direction side. In addition, the second housing tubular portion 45 can be attached to the side plate portion 42 by, for example, fixing with a screw, but is not limited thereto, and a method of firmly fixing the second housing tubular portion 45 to the side plate portion 42, such as screwing or press-fitting, can be widely adopted. As a result, the second housing tubular portion 45 can be brought into close contact with the end portion of the side plate portion 42 which is located on the +Y direction side.

The gear lid portion 46 expands in a direction intersecting the first rotation axis J1. In the present embodiment, the second housing tubular portion 45 and the gear lid portion 46 are integrated. However, the present invention is not limited to this example, and both may be separate bodies.

The gear lid portion 46 includes a second drive shaft through-hole 460. The second drive shaft through-hole 460 penetrates the gear lid portion 46 in the Y-axis direction. The center of the second drive shaft through-hole 460 coincides with a third rotation axis J3. The second drive shaft Ds2 extends through the second drive shaft through-hole 460. An oil seal (not illustrated) is disposed in a gap between the second drive shaft Ds2 and the second drive shaft through-hole 460.

The gear lid portion 46 further includes a second gear bearing holder 461, a second intermediate bearing holder 462, and a second drive bearing holder 463. The second gear bearing holder 461 and the second intermediate bearing holder 462 are arranged on the end surface of the gear lid portion 46 which is located on the −Y direction side. The second gear bearing holder 461 holds a second gear bearing 4611. The second gear bearing 4611 rotatably supports the end portion of the gear shaft 12 which is located on the +Y direction side. The second intermediate bearing holder 462 holds the second intermediate bearing 4621. The second intermediate bearing 4621 rotatably supports the end portion of the intermediate shaft 314 which is located on the +Y direction side. The second drive bearing holder 463 is disposed on the inner surface of the second drive shaft through-hole 460 and holds a second drive bearing 4631. The second drive bearing 4631 rotatably supports the second drive shaft Ds2.

The gear lid portion 46 has a flow path 464. The flow path 464 is a passage for the fluid FL and connects a tray portion 465 and the inlet 121 of the motor shaft 1. The tray portion 465 has a recess portion recessed in the −Z direction. The tray portion 465 can store the fluid FL scraped up by the gear (for example, the fourth gear 321) of the gear portion 3. In the present embodiment, the gear lid portion 46 has the tray portion 465. The tray portion 465 is disposed on the end surface of the gear lid portion 46 which is located on the −Y direction side and extends in the −Y direction. The fluid FL stored in the tray portion 465 is supplied to the flow path 464 and flows into the motor shaft 1 from the inlet 121 at the end portion of the motor shaft 1 which is located on the +Y direction side.

The motor housing 401 accommodates the motor 2. As described above, the housing 4 has the motor housing 401. More specifically, the motor housing 401 accommodates the rotor shaft 11, the rotor 21, the stator 22, and the like. In the present embodiment, the motor housing 401 includes the first housing tubular portion 41, the side plate portion 42, and the housing lid portion 43.

The gear housing 402 accommodates the gear shaft 12 and the gear portion 3. In the present embodiment, the gear housing 402 includes the side plate portion 42, the second housing tubular portion 45, and the gear lid portion 46.

A fluid reservoir P in which the fluid FL is accumulated is disposed in a lower portion of the gear housing 402. A part of the gear portion 3 (for example, the fourth gear 321) is immersed in the fluid reservoir P. The fluid FL accumulated in the fluid reservoir P is scraped up by the operation of the gear portion 3 and supplied to the inside of the gear housing 402. For example, the fluid FL is scraped up by the tooth surface of the fourth gear 321 when the fourth gear 321 of the differential device 32 rotates. A part of the scraped fluid FL is supplied to the gears and the bearings of the reduction gear 31 and the differential device 32 in the gear housing 402 and used for lubrication. In addition, other part of the scraped fluid FL is stored in the tray portion 465, supplied to the inside of the motor shaft 1, supplied to the rotor 21 and the stator 22 of the motor 2 and the bearings in the gear housing 402, and used for cooling and lubrication.

The inverter housing 403 houses the inverter 6. As described above, the housing 4 further includes the inverter housing 403. The inverter housing 403 is disposed closer to one side (for example, the +Z direction) in the Z axis direction perpendicular to the Y axis direction and the X axis direction than the motor housing 401. The inverter housing 403 includes a bottom plate portion 471, a peripheral wall portion 472, and a lid portion 473. The bottom plate portion 471 expands in the −X direction from the end portion of the first housing tubular portion 41 which is located on the +Z direction side. The peripheral wall portion 472 protrudes from the bottom plate portion 471 in the +Z direction. The peripheral wall portion 472 surrounds the inverter 6 when viewed from the Z-axis direction. The lid portion 473 covers the end portion of the peripheral wall portion 472 which is located on the +Z direction side.

The fluid circulation portion 5 will be described next. The fluid circulation portion 5 includes a pipe portion 51, a pump 52, a heat exchanger 53, and a fluid reservoir 54.

The pipe portion 51 connects the pump 52 and the fluid reservoir 54 disposed inside the first housing tubular portion 41. The pump 52 sucks the fluid FL stored in the fluid reservoir P and supplies the fluid FL to the fluid reservoir 54. The pump 52 is an electric pump in the present embodiment.

The heat exchanger 53 is disposed between the pump 52 and the fluid reservoir 54 in the pipe portion 51. That is, the fluid FL sucked by the pump 52 is sent to the fluid reservoir 54 after passing through the heat exchanger 53 via the pipe portion 51. A fluid Fr is supplied from the cooling flow path 7 to the heat exchanger 53. The heat exchanger 53 can exchange the fluid FL for cooling the motor 2 with the fluid Fr. The drive apparatus 100 includes the heat exchanger 53. The fluid Fr is an example of the “first fluid” according to the present invention. The fluid FL is an example of the “second fluid” according to the present invention. The temperature of the fluid FL can be lowered by heat exchange between the two fluids. In the present embodiment, as illustrated in FIG. 2, the heat exchanger 53 is disposed at the end portion of the motor housing 401 which is located on the −Z direction side. This configuration prevents the drive apparatus 100 from increasing in size in the X-axis direction due to the attachment of the heat exchanger 53. Further, the heat exchanger 53 is disposed on the +X direction side of the motor housing 401, and specifically, is disposed on the +X direction side at the end portion of the motor housing 401 which is located on the −Z direction side.

The fluid reservoir 54 is a tray disposed vertically above the stator 22 inside the motor housing 401. A dropping hole (whose reference sign is omitted) is formed at a bottom of the fluid reservoir 54, and the motor 2 is cooled by dropping the fluid FL from the dropping hole. The dropping hole is formed above the coil end 2221 of the coil portion 222 of the stator 22, for example, and the coil portion 222 is cooled by the fluid FL.

The inverter 6 supplies power to the motor 2. As described above, the drive apparatus 100 includes the inverter 6. More specifically, the inverter 6 supplies a drive current to the stator 22. The inverter 6 includes a first element 61 and a second element 62. The first element 61 and the second element 62 are arranged in the X-axis direction perpendicular to the Y-axis direction. The first element 61 is disposed in the −X direction with respect to the second element 62. One of the first element 61 and the second element 62 is a switching element, and is, for example, an insulated gate bipolar transistor (IGBT) or a SiC-MOSFET. The other of first element 61 and second element 62 is a capacitive element, and is, for example, a large-capacity capacitor such as an electrolytic capacitor.

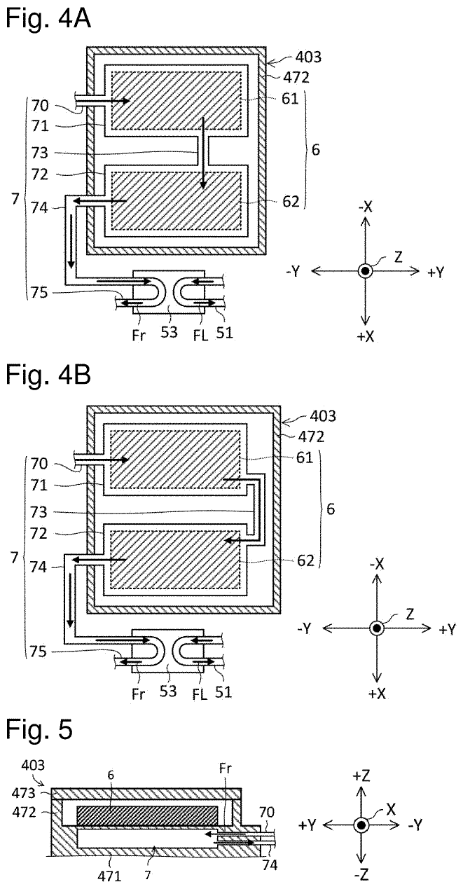

The cooling flow path 7 will be described with reference to FIGS. 1, 2, and FIGS. 4A to 5. FIG. 4A is a schematic view illustrating a configuration example of the cooling flow path 7 according to the embodiment. FIG. 4B is a schematic view illustrating another configuration example of the cooling flow path 7 in the embodiment. FIG. 5 is a conceptual diagram illustrating another arrangement example of the cooling flow path 7 in the inverter housing 403. Referring to FIGS. 4A and 4B, the cooling flow path 7 is viewed from the +Z direction to the −Z direction.

The fluid Fr for cooling the inverter 6 can flow through the cooling flow path 7. As described above, the drive apparatus 100 includes the cooling flow path 7. The fluid Fr is water in the present embodiment but is not limited to this example, and may be, for example, oil (particularly for a refrigerant).

The cooling flow path 7 includes an inflow flow path 70, a first cooling portion 71, a second cooling portion 72, a first connection flow path 73, a second connection flow path 74, and a circulation flow path 75.

One end of the inflow flow path 70 is connected to the end portion of the first cooling portion 71 which is located on the −Y direction side. The other end of the inflow flow path 70 is connected to a circulation pump (not shown) disposed outside the inverter housing 403. The inflow flow path 70 extends through the inverter housing 403 from the outside and supplies the fluid Fr delivered from the circulation pump described above to the first cooling portion 71.

The first cooling portion 71 cools the first element 61 with the fluid Fr. As described above, the cooling flow path 7 includes the first cooling portion 71. As illustrated in FIGS. 4A and 4B, the first cooling portion 71 is aligned with the second cooling portion 72 in the X-axis direction and is disposed in the −X direction with respect to the second cooling portion 72. In the Z-axis direction, the first cooling portion 71 overlaps at least a part of the first element 61 and preferably overlaps the entire first element 61 as illustrated in FIGS. 4A and 4B.

The second cooling portion 72 cools the second element 62 with the fluid Fr. As described above, the cooling flow path 7 includes the second cooling portion 72. In the Z-axis direction, the second cooling portion 72 overlaps at least a part of the second element 62 and preferably overlaps the entire second element 62 as illustrated in FIGS. 4A and 4B.

The first connection flow path 73 connects the first cooling portion 71 and the second cooling portion 72. As described above, the cooling flow path 7 includes the first connection flow path 73. The fluid Fr flows from the first cooling portion 71 to the second cooling portion 72 through the first connection flow path 73. The end portion of the first connection flow path 73 which is located on the −X direction side is connected to the first cooling portion 71. The end portion of the first connection flow path 73 which is located on the +X direction side is connected to the second cooling portion 72. Preferably, the connection portion between the first connection flow path 73 and the first cooling portion 71 is disposed at a position farther away from the other end of the inflow flow path 70. In this way, the stagnation of the fluid Fr in the first cooling portion 71 can be suppressed.

Referring to FIG. 4A, the first connection flow path 73 is disposed between the first cooling portion 71 and the second cooling portion 72 in the X-axis direction and extends in the X-axis direction. The end portion of the first connection flow path 73 which is located on the −X direction side is connected to the end portion of the first cooling portion 71 which is located on the +X direction side. The end portion of the first connection flow path 73 which is located on the +X direction side is connected to the end portion of the second cooling portion 72 which is located on the −X direction side. In this way, it is not necessary to secure a space for disposing the first connection flow path 73 on the +Y direction side or the −Y direction side with respect to the first cooling portion 71 and the second cooling portion 72. Therefore, the sizes of the first cooling portion 71 and the second cooling portion 72 in, for example, the Y-axis direction can be further increased. This can improve the cooling performance of the first cooling portion 71 and the second cooling portion 72.

On the other hand, referring to FIG. 4B, the first connection flow path 73 is disposed on the +Y direction side with respect to the first cooling portion 71 and the second cooling portion 72 and extends in the X-axis direction. The end portion of the first connection flow path 73 which is located on the −X direction side is connected to the end portion of the first cooling portion 71 which is located on the +Y direction side. The end portion of the first connection flow path 73 which is located on the +X direction side is connected to the end portion of the second cooling portion 72 which is located on the +Y direction side. This eliminates the need to secure a space for disposing the first connection flow path 73 between the first cooling portion 71 and the second cooling portion 72, thereby further reducing the interval between the first cooling portion 71 and the second cooling portion 72 in the X-axis direction. Therefore, the cooling flow path 7 can be disposed more compactly in the inverter housing 403. Furthermore, even if the first element 61 is disposed at a position closer to the second element 62 in the X-axis direction, the first cooling portion 71 and the second cooling portion 72 can be disposed at positions overlapping the first element and the second element in the Z-axis direction, so that the first cooling portion and the second cooling portion can be sufficiently cooled. The example in FIG. 4B does not exclude the configuration in which the first connection flow path 73 is disposed between the first cooling portion 71 and the second cooling portion 72 on the −Y direction side with respect to the first cooling portion 71 and the second cooling portion 72.

The second connection flow path 74 connects the second cooling portion 72 and the heat exchanger 53. As described above, the cooling flow path 7 includes the second connection flow path 74. One end of the second connection flow path 74 is connected to the end portion of the second cooling portion 72 which is located on the −Y direction side. The second connection flow path 74 is drawn from the inside to the outside of the inverter housing 403. The other end of the second connection flow path 74 is connected to the heat exchanger 53. The fluid Fr flows from the second cooling portion 72 to the heat exchanger 53 through the second connection flow path 74. The fluid Fr delivered from the heat exchanger 53 is delivered from the heat exchanger 53 to the circulation pump through a circulation flow path 75 connecting the heat exchanger 53 and the circulation pump. Preferably, the connection portion between the second connection flow path 74 and the second cooling portion 72 is disposed at a position farther away from the connection portion between the first connection flow path 73 and the first cooling portion 71. In this way, the stagnation of the fluid Fr in the second cooling portion 72 can be suppressed.

As illustrated in FIGS. 4A and 4B, in the cooling flow path 7, the fluid Fr flows through the first cooling portion 71, the first connection flow path 73, the second cooling portion 72, the second connection flow path 74, and the heat exchanger 53 in this order. Accordingly, after cooling the first element 61 and the second element 62 of the inverter 6 in this order, the fluid Fr can exchange heat with the fluid FL in the heat exchanger 53. As described above, in the present embodiment, the fluid Fr is water, and the fluid FL is a lubricating oil (ATF) of the drive apparatus 100. Therefore, the fluid Fr can sufficiently cool the fluid FL even after cooling the inverter 6. Further, due to the circulation in the above-described order, the cooling flow path 7 from the first cooling portion 71 to the heat exchanger 53 hardly crosses itself inside the inverter housing 403. Therefore, the arrangement of the cooling flow path 7 of the inverter 6 can be made simpler. In addition, this makes it possible to suppress an increase in the size of the inverter housing 403, thereby contributing to the downsizing of the drive apparatus 100.

Preferably, the heat exchanger 53, the second cooling portion 72, and the first cooling portion 71 are arranged in this order from the +X direction toward the −X direction. By simplifying the arrangement of the heat exchanger 53, the first cooling portion 71, and the second cooling portion 72, the cooling flow path 7 can have a simple configuration.

In the present embodiment, as illustrated in FIG. 1, a part of the cooling flow path 7 is formed in the lid portion 473. More specifically, the first cooling portion 71, the second cooling portion 72, and the first connection flow path 73 are arranged inside the lid portion 473. In other words, the lid portion 473 includes the first cooling portion 71, the second cooling portion 72, and the first connection flow path 73. The first element 61 and the second element 62 are arranged at the end portion of the lid portion 473 which is located on the −Z direction side.

More specifically, the first element 61 is disposed in the −Z direction with respect to the first cooling portion 71. The second element 62 is disposed in the −Z direction with respect to the second cooling portion 72. This makes it possible to more freely design the cooling flow path 7 of the fluid Fr.

Note that the present invention is not limited to the example of the present embodiment, and a part of the cooling flow path 7 may be formed in the bottom plate portion 471 as illustrated in FIG. 5. For example, the first cooling portion 71, the second cooling portion 72, and the first connection flow path 73 may be arranged inside the bottom plate portion 471. In this case, the first element 61 and the second element 62 are arranged at the end portion of the bottom plate portion 471 which is located on the +Z direction side.

Note that the above-described example does not exclude a configuration in which a part of the cooling flow path 7 is disposed outside the bottom plate portion 471 and the lid portion 473. For example, the first cooling portion 71, the second cooling portion 72, and the first connection flow path 73 may be arranged in a space surrounded by the bottom plate portion 471, the peripheral wall portion 472, and the lid portion 473. In this case, for example, the first element 61 is in contact with the end portion of the first cooling portion 71 which is located on the +Z direction side or the −Z direction side. The second element 62 is in contact with the end portion of the second cooling portion 72 which is located on the +Z direction side or the −Z direction side.

In the present embodiment, as described above, one of the first element 61 and the second element 62 is a switching element, and for example, the switching element is a power switching element such as an insulated gate bipolar transistor (IGBT) or a SiC-MOSFET. The other of first element 61 and second element 62 is a capacitive element, and is, for example, a large-capacity capacitor such as an electrolytic capacitor. Even if the first element 61 and the second element 62 are electronic components having a large amount of heat generation as described above, the cooling flow path 7 can sufficiently cool them with the fluid Fr.

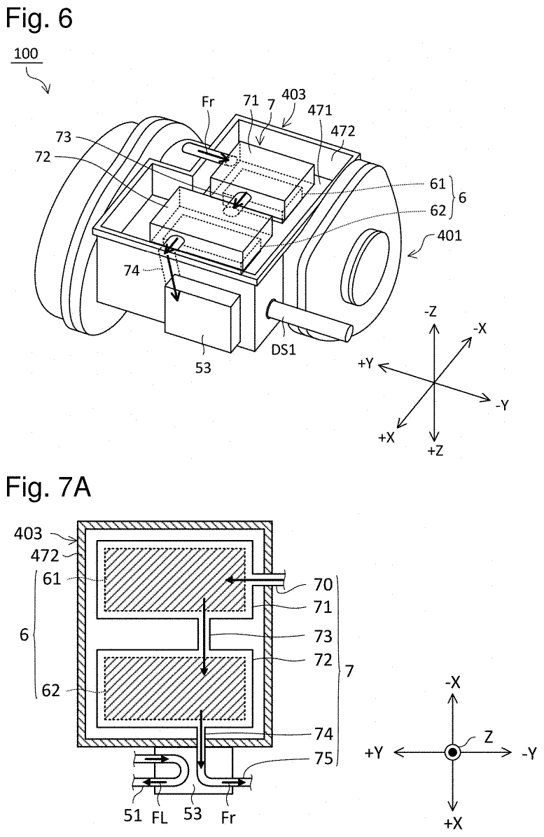

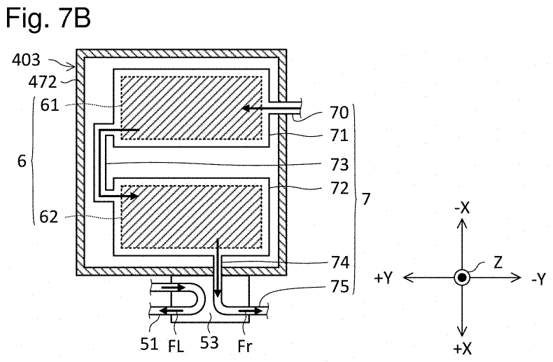

A modification of the embodiment will be described next with reference to FIGS. 6 to 7B. FIG. 6 is a perspective view of the drive apparatus 100 according to a modification. FIG. 7A is a schematic view illustrating a configuration example of the cooling flow path 7 according to the modification. FIG. 7B is a schematic view illustrating another configuration example of the cooling flow path 7 in the modification. Referring to FIG. 6, in order to make the configuration of a cooling flow path 7 easily viewable, a portion other than the cooling flow path 7 of a lid portion 473 is omitted. Referring to FIGS. 7A and 7B, the cooling flow path 7 is viewed from the +Z direction to the −Z direction. In the modification, the +X direction is the rear side of the vehicle 300, and the −X direction is the front side of the vehicle 300. However, the +X direction may be the front of the vehicle 300, and the −X direction may be the rear of the vehicle 300.

Referring to FIG. 6, it should be noted that the +X direction and the −X direction are opposite to those in FIG. 2 according to the embodiment. Referring to FIGS. 7A and 7B, it should be noted that the +Y direction and the −Y direction are opposite to those in FIGS. 4A and 4B according to the embodiment. However, in the modification, similarly to the above-described embodiment, the +X direction is an example of “one of the second directions” according to the present invention. The −X direction is an example of “the other of the second directions” according to the present invention. The +Y direction is an example of “one of the first directions” according to the present invention. The −Y direction is an example of “the other of the first directions” according to the present invention.

Hereinafter, the configurations different from the above-described embodiment will be described. In addition, the same components as those in the above-described embodiment are denoted by the same reference signs, and the description thereof may be omitted.

In the modification, the heat exchanger 53 is disposed in the inverter housing 403. For example, as illustrated in FIG. 6, the heat exchanger 53 is disposed at the end portion of the peripheral wall portion 472 which is located on the +X direction side. However, the present invention is not limited to the example in FIG. 6, and the heat exchanger 53 may be disposed at the end portion of the bottom plate portion 471 which is located on the −Z direction side. This configuration prevents the drive apparatus 100 from increasing in size in, for example, the Z-axis direction due to the attachment of the heat exchanger 53. In addition, since the heat exchanger 53 can be disposed near the second cooling portion 72, the second connection flow path 74 can be further shortened (see FIGS. 7A and 7B). Therefore, the cooling flow path 7 can be made more compact.

In the cooling flow path 7 according to the modification, as illustrated in FIGS. 7A and 7B, the inflow flow path 70 extends through the inverter housing 403 from the outside and is connected to the end portion of the first cooling portion 71 which is located on the −Y direction side. The first cooling portion 71 is disposed side by side with the second cooling portion 72 in the X-axis direction and is disposed in the −X direction with respect to the second cooling portion 72. Referring to FIG. 7A, the first connection flow path 73 is disposed between the first cooling portion 71 and the second cooling portion 72 in the X-axis direction. Referring to FIG. 7B, the first connection flow path 73 is disposed between the first cooling unit 71 and the second cooling unit 72 on the +Y direction side with respect to the first cooling unit 71 and the second cooling unit 72. The second connection flow path 74 is drawn out from the inside of the inverter housing 403 to the outside and connects the second cooling unit 72 and the heat exchanger 53. The fluid Fr delivered from the heat exchanger 53 is delivered from the heat exchanger 53 to the circulation pump for the fluid Fr through the circulation flow path 75 connecting the heat exchanger 53 and the circulation pump.

In the modification, as in the above-described embodiment, in the cooling flow path 7, the fluid Fr flows through the first cooling portion 71, the first connection flow path 73, the second cooling portion 72, the second connection flow path 74, and the heat exchanger 53 in this order. Accordingly, after cooling the first element 61 and the second element 62 of the inverter 6 in this order, the fluid Fr can exchange heat with the fluid FL in the heat exchanger 53. Further, due to the circulation in the above-described order, the cooling flow path 7 from the first cooling portion 71 to the heat exchanger 53 hardly crosses itself inside the inverter housing 403. Therefore, the arrangement of the cooling flow path 7 of the inverter 6 can be made simpler.

In the modification, the first cooling portion 71 and the second cooling portion 72 are arranged in the X-axis direction. Preferably, the heat exchanger 53, the second cooling portion 72, and the first cooling portion 71 are arranged in this order from the +X direction toward the −X direction. By simplifying the arrangement of the heat exchanger 53, the first cooling portion 71, and the second cooling portion 72, the cooling flow path 7 can have a simple configuration.

In the modification, a part of the cooling flow path 7 is formed in the lid portion 473. For example, the first cooling portion 71, the second cooling portion 72, and the first connection flow path 73 are arranged inside the lid portion 473. However, the present invention is not limited to this example, and a part of the cooling flow path 7 may be formed in the bottom plate portion 471. For example, the first cooling portion 71, the second cooling portion 72, and the first connection flow path 73 may be arranged inside the bottom plate portion 471 (see FIG. 5). These examples do not exclude a configuration in which a part of the cooling flow path 7 is disposed outside the bottom plate portion 471 and the lid portion 473. For example, the first cooling portion 71, the second cooling portion 72, and the first connection flow path 73 may be arranged in a space surrounded by the bottom plate portion 471, the peripheral wall portion 472, and the lid portion 473.

The embodiment of the present invention has been described above. Note that the scope of the present invention is not limited to the above-described embodiment. The present invention can be implemented by making various modifications to the above-described embodiment within a range not departing from the gist of the invention. In addition, the matters described in the above-described embodiments are arbitrarily combined together as appropriate within a range where no inconsistency occurs.

In the present embodiment and the modification, the present invention is applied to the in-vehicle drive apparatus 100. However, the present invention is not limited to this example, and the present invention is also applicable to drive apparatuses or the like used for applications other than in-vehicle applications.

The present invention is useful, for example, in an apparatus that makes a fluid for cooling an inverter flow into a heat exchanger.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive apparatus comprising:
a motor;
an inverter configured to supply power to the motor;
a motor housing configured to accommodate the motor;
an inverter housing configured to accommodate the inverter;
a cooling flow path through which a first fluid for cooling the inverter is configured to flow; and
a heat exchanger configured to cause a second fluid for cooling the motor to exchange heat with the first fluid,
wherein the motor includes a motor shaft that extends along a central axis parallel to a first direction and is rotatable about the central axis,
the inverter includes a first element and a second element,
the first element and the second element are arranged in a second direction perpendicular to the first direction, and
the cooling flow path includes a first cooling portion configured to cool the first element with the first fluid, a second cooling portion configured to cool the second element with the first fluid, a first connection flow path connecting the first cooling portion and the second cooling portion, and a second connection flow path connecting the second cooling portion and the heat exchanger.

2. The drive apparatus according to claim 1, wherein in the cooling flow path, the first fluid sequentially flows through the first cooling portion, the first connection flow path, the second cooling portion, the second connection flow path, and the heat exchanger.

3. The drive apparatus according to claim 1, wherein
the heat exchanger is disposed on one side of one of the inverter housing and the motor housing which is located in the second direction, and
the heat exchanger, the second cooling portion, and the first cooling portion are sequentially arranged from one side to the other side in the second direction.

4. The drive apparatus according to claim 3, wherein
the inverter housing is disposed on one side in a third direction perpendicular to the first direction and the second direction with respect to the motor housing,
the inverter housing includes a peripheral wall surrounding the inverter as viewed from the third direction and a lid portion covering an end portion of the peripheral wall portion which is located on one side in the third direction,
the first cooling portion, the second cooling portion, and the first connection flow path are arranged inside the lid portion, and
the first element and the second element are arranged at an end of the lid portion which is located on the other side in the third direction.

5. The drive apparatus according to claim 4, wherein the heat exchanger is disposed at an end portion of the motor housing which is located on the other side in the third direction.

6. The drive apparatus according to claim 1, wherein the heat exchanger is disposed in the inverter housing.

7. The drive apparatus according to claim 1, wherein one of the first element and the second element is a switching element, and the other is a capacitive element.
